(19) United States
(12) Patent Application Publication
(10) Pub. No.: US 2010/0279731 A1
(43) Pub. Date: Nov. 4, 2010

(54) Techniques for communications among access and core networks

(76) Inventor: Puneet Jain, Hillsboro, OR (US)

Correspondence Address: INTEL CORPORATION;c/o CPA Global, P.O. BOX 52050, MINNEAPOLIS, MN, 55402, US

(21) Appl. No.: 12/387,435

(22) Filed: May 1, 2009

(51) Int. Cl. H04W 48/18

(52) U.S. Cl. 455/552.1

(57) ABSTRACT

Techniques for attaching a user device to a core network are disclosed. For example, a user device may send a request message to a wireless access network that requests attachment to a core network. In return, the user device receives a response message from the wireless access network that indicates whether the request is granted. The request message may include various information fields, such as a field to indicate an attachment type, a field to indicate an access point name, and a field to indicate a mobility mode capability of the device. The wireless access network may be an IEEE 802.16e WiMAX network and the core network may be a 3GPP enhanced packet core (EPC).

### BACKGROUND

Wireless communications capabilities are increasingly being integrated into portable devices, including laptop computers, handheld devices (such as personal digital assistants (PDAs)), and mobile phones. The integration of such capabilities can provide users with anywhere and anytime connectivity to information resources.

Mobile device users typically desire to obtain packet services through their devices. Examples of packet services include Voice over Internet Protocol (VoIP) telephony, messaging, web browsing, content (e.g., video and/or audio) delivery, and interactive gaming. Often, such services are provided by networks that are external a mobile device's wireless access network.

In such situations, access to services from external networks may be obtained through a core network. Accordingly, achieving such access may involve the employment of internetworking techniques between a mobile device's wireless access network and a core network.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary operational environment;

FIG. 2 is a flow diagram showing exemplary network operations;

FIGS. 3 and 4 are diagrams showing exemplary network interactions;

FIG. 5 is a diagram of an implementation that may be employed in a user device; and

FIG. 6 is a diagram of an implementation that may be employed in a access services network gateway.

### DETAILED DESCRIPTION

Embodiments provide techniques for a user device to attach to a core network. For example, a user device may send a request message to a wireless access network that requests attachment to a core network. In return, the user device receives a response message from the wireless access network that indicates whether the request is granted. The request message may include various information fields, such as a field to indicate an attachment type, a field to indicate an access point name, and a field to indicate a mobility mode capability of the device. The wireless access network may be an IEEE 802.16e WiMAX network and the core network may be a 3GPP enhanced packet core (EPC). However, other types of networks may be employed.

Thus, embodiments may provide a mechanism to send non-access stratum (NAS) information. This mechanism involves new signaling messages that are conveyed between a user device and an access services network (ASN). In embodiments, this mechanism is extensible. For instance, such new signaling messages may be used to carry additional and/or alternative information elements, if needed.

Reference throughout this specification to “one embodiment” or “an embodiment” means that a particular feature, structure, or characteristic described in-connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

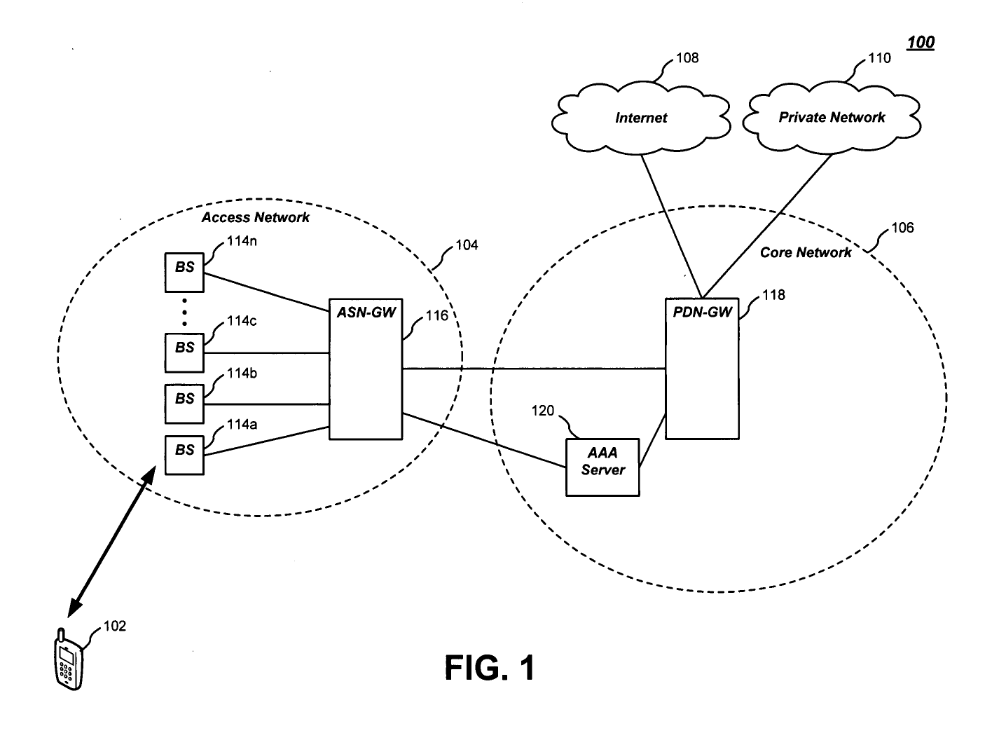

FIG. 1 is a diagram of an exemplary operational environment 100 in which the techniques described herein may be employed. As shown in FIG. 1, this environment includes a user device 102, an access network 104, a core network 106, the Internet 108, and a private network 110.

User device 102 provides a user with mobile communications capabilities. Accordingly, user device 102 may be a mobile telephone, a smartphone, a wireless personal digital assistant (PDA), a mobile internet device (MID), a notebook computer, a netbook, a nettop, and so forth. Embodiments are not limited to these examples.

Mobile communications of user device 102 are facilitated through one or more wireless access networks. As an example, FIG. 1 shows user device 102 engaging in wireless communications with access network 104. In embodiments, access network 104 may be a wireless network such as an Institute of Electrical and Electronics Engineers (IEEE) 802.16e WiMAX network. However, other network types may be employed. Examples of such other network types include (but are not limited to) IEEE 802.16m networks, and IEEE 802.11 wireless local area networks (WLANs).

Access network 104 may include one or more elements implemented in any combination of hardware and/or software. For instance, access network 104 may include one or more base stations (BSs) that exchange wireless signals with user devices. As an example, FIG. 1 shows access network 102 having multiple BSs 114a-114n. Of these, FIG. 1 shows user device 102 exchanging wireless signals with BS 114a. However, user device 102 may exchange signals with any combination of base stations.

In addition to having one or more base stations, access network 104 may include an access services network gateway (ASN-GW) 116. ASN-GW 116 may provide various features involving the interaction of user device 102 with access network 104. For instance, ASN-GW 116 may perform authentication operations, handle mobile Internet Protocol (IP) (e.g., proxy mobile IP (PMIP), mobility IP (MIP), client mobile IP (CMIP), etc.) operations, perform paging, distribute encryption keys, and/or perform handover functions. These features are provided as examples, and not as limitations. Accordingly, ASN-GW 116 may provide any combination of these, as well as other, features.

In addition, ASN-GW 116 may perform operations involving the attachment of user device 102 to core network 106. This attachment provides user device 102 with access to external network(s) (or access points) through core network 106. As described herein, such attachment operations may involve the exchange of particular messages between user device 102 and ASN-GW 116.

Core network 106 may make various services available to user devices. For instance, core network 106 may provide user device 102 with access to services provided on networks (also referred to as access points), such as Internet 108 and private network 110. Exemplary services include (but are not limited to) Voice over Internet Protocol (VoIP) telephony, messaging, web browsing, content (e.g., video and/or audio) delivery, interactive gaming, and so forth.

In embodiments, core network 106 may be implemented in accordance with the Evolved Packet Core (EPC) of the Long Term Evolution (LTE) specification (e.g., LTE release 8) of the Third Generation Partnership Project (3GPP). However, embodiments are not limited to this exemplary core network implementation.

Core network 106 may include one or more elements implemented in any combination of hardware and/or software. For instance, FIG. 1 shows core network 106 including a packet data network gateway (PDN-GW) 118. PDN-GW 118 provides user device 102 with connectivity to external packet data networks (or access points) by operating as a traffic interface point for user device 102. In addition, PDN-GW 118 may perform one or more various additional operations, such as local mobility anchor (LMA), home agent (HA), packet filtering, policy enforcement for user device 102, and/or charging for user device 102. Embodiments, however, are not limited to these exemplary operations.

FIG. 1 further shows that ASN-GW 116 (of access network 104) is coupled to PDN-GW 118 (of core network 106). Thus, in embodiments, user device 102 enjoys access to PDN-GW 118 through ASN-GW 116.

Also, FIG. 1 shows that core network 106 includes an authentication, authorization and accounting AAA server 120. AAA server 120 may provide authentication services for ASN-GW 116 and/or PDN-GW 118. Thus, FIG. 1 further shows AAA server 120 coupled to ASN-GW 116 and PDN-GW 118. These connections may be provided through one or more dedicated networks, private, and/or public networks (e.g., the Internet). Moreover, AAA server 120 may be implemented with any combination of hardware and/or software.

In embodiments, AAA server 120 may perform operations involving the authentication of user device 102. In situations where user device 102 is roaming (e.g., when access network 104 is not the home access network of user device 102), AAA server 120 may operate as a proxy. This involves AAA server 120 relaying authentication-related traffic to/from another AAA server that is associated with user device 102. Communications with AAA server 120 may be in accordance with various authentication protocols. Exemplary protocols include (but are not limited to) extensible authentication protocol (EAP), DIAMETER, and/or remote authentication dial in user service (RADIUS).

As described above, user device 102 may obtain access to one or more external packet networks via core network 106. FIG. 1 shows Internet 108 (e.g., the global Internet), and a private network 110 as exemplary packet networks. Private network 110 may be, for example, a restricted access network (e.g., a corporate network). These external networks are provided merely for purposes of illustration, and not limitation. Accordingly, other external networks may be employed.

In general operation, user device 102 may exchange wireless signals with one or more of base stations I 14a-114n within access network 104. This may allow user device 102 to engage in communications with external packet networks through core network 106 (e.g., through (PDN-GW 118). As described above, such communications may be associated with services, such as (but are not limited to) voice over Internet Protocol (VoIP) telephony, messaging, web browsing, content (e.g., video and/or audio) delivery, interactive gaming, and so forth.

Such communications may involve the transfer of Internet Protocol (IP) packets. Moreover, such communications may employ mobile IP protocols, such as proxy mobile IP (PMIP). These protocols allow mobile devices (such as user device 102) to roam among networks (e.g., access networks) while maintaining a permanent IP address. Such communications involve the establishment of IP tunnels. As described above, other exemplary mobile IP protocols include (but are not limited to) MIP and CMIP.

Once user device 102 has established communications with access network 104, it needs to get a packet data network (PDN) connection to core network 106 before it can obtain services from external networks (e.g., from networks 110 and/or 112). This involves providing certain information to access network 104.

For example, in the context of access network 104 being a WIMAX network, and core network 106 being a 3GPP EPC, user device 102 will need to convey certain information such as a 3GPP access point name (APN), and an attach type parameter to ASN-GW I 16. The APN identifies a service offered by an external network and helps in resolving the IP address of PDN-GW via a DNS query. The attach type parameter indicates the particular type of attachment requested (e.g., initial attachment or handover attachment or additional PDN attachment). Currently WiMAX standards do not specify mechanisms for such information to be sent from a user device (also referred to as a mobile station) and an access network (also referred to as an access services network (ASN)).

Embodiments provide such mechanisms through the employment of two messages. The first message is a request message that is sent from a user device to an access network. This message contains information needed to attach to a core network. The second message is a corresponding response message that the access network indicates to the user device whether attachment has occurred. These messages may act as generic container for the purpose of conveying inter-technology non-access stratum (NAS) information, such as an access point name, an attach type parameter, and mobility mode information. Embodiments, however, are not limited to this information. For instance, messages may convey other NAS information.

Operations for the embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

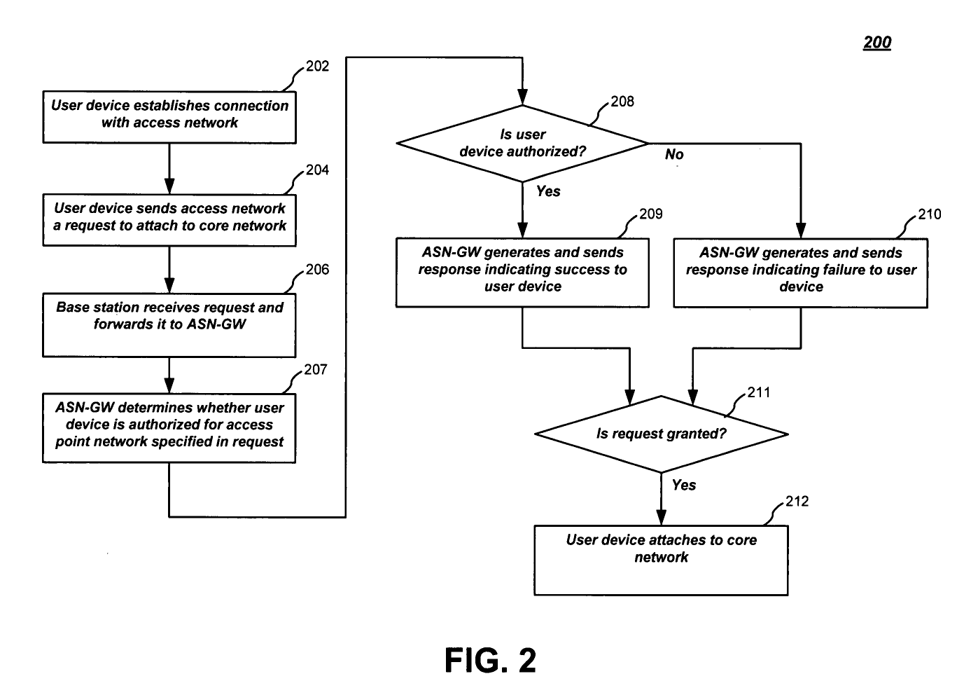

FIG. 2 illustrates an embodiment of a logic flow. In particular, FIG. 2 illustrates a logic flow 200, which may be representative of the operations executed by one or more embodiments described herein. This flow is described in the context of FIG. 1. However, this flow may be employed in other contexts. Although FIG. 2 shows a particular sequence, other sequences may be employed. Also, the depicted operations may be performed in various parallel and/or sequential combinations.

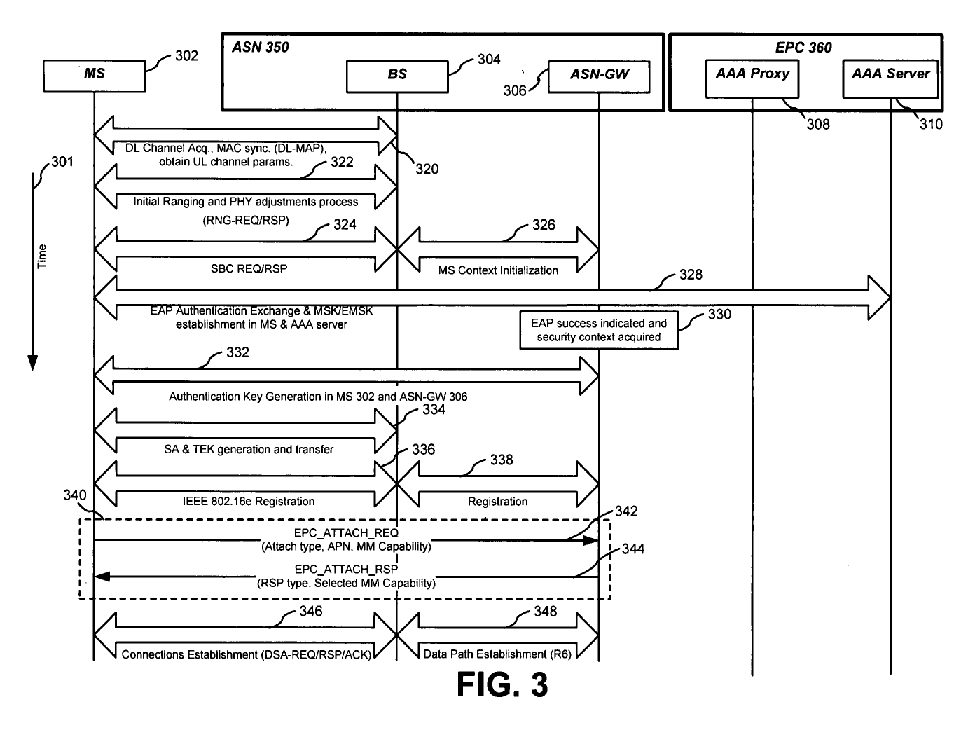

At a block 202, user device 102 establishes a connection with access network 104. This may involve various operations, Such operations may include (but are not limited to) establishing downlink (DL) and uplink (UL) parameters, establishing media access control (MAC) synchronization, performing ranging and physical layer (PHY) adjustments, the exchange of basic capability messages, authentication operations, establishment of encryption keys, network registration, and so forth. Examples of such operations are described below with reference to FIG. 3. As a result of this connection, user device 102 may engage in communications with one or more of base stations 114a-n.

At a block 204, user device 102 sends a request message to access network 104. In particular, this message is a request to attach to core network 106. This message may include various information fields. For instance, this message may include an attach type field, an access point name (APN) field, and a mobility mode (MM) capability field.

The attach type field indicates whether this request is for an initial attachment, a handover attachment, or an additional PDN attachment. The APN field identifies a service offered by a particular external network to which user device 102 wants access. For example, in the context of FIG. 1, the APN field may identify a service offered by external network 108 and/or external network 110. In embodiments, the APN indication may be in the form of a string with labels separated by dots, such as “Label1.Label2.Label3”.

The MM capability field indicates one or more mobility protocols that user device 102 is capable of employing. Examples of such protocols include PMIP (e.g., PMIP version 6 address preservation), MIP (e.g., MIP version 4 FA care of address (CoA)), and client mobile IP (e.g., CMIP version 6).

At a block 206, this request message is received by the base station in communication with user device 102. In turn, the request message is transparently forwarded to ASN-GW 116 within access network 104.

Upon receipt, ASN-GW 116 determines (or validates), at a block 207, whether user device 102 is authorized for the APN identified in the request message. This may involve checking with the information received from one or more AAA servers (e.g., AAA server 120).

As indicated by block 208-210, ASN-GW 116 prepares and sends a response message to user device 102 based on whether user device 102 is authorized for the APN. For instance, if user device 102 is authorized, ASN-GW 116 prepares and sends a response message indicating success (or request granted) at block 209. Otherwise, ASN-GW 116 prepares and sends a response message indicating failure (or request denied) at block 210.

The response messages of blocks 209 and 210 may share a particular format. For example, such response messages may include multiple information fields. Exemplary information fields include (but are not limited to) a response type field, and a selected mobility mode (MM) capability field.

The response type field (RSP Type) indicates whether the request was denied (“failure”) or granted (“successful”). The selected mobility mode capability indicates a mobility protocol (e.g., PMIP, MIP, CMIP, etc.) to be employed by user device 102.

As indicated by a block 211, operation may proceed to a block 212 if the request is granted. At block 212, user device 102 attaches to core network 106. In embodiments, this involves user device 102 exchanging messages with its corresponding base station, and the establishment of a data path with the access point (external network) through ASN-GW 116 and PDN-GW 118.

As described above, in embodiments, access network 104 may be a WiMAX network, and core network 106 may be a 3GPP EPC. FIG. 3 is a diagram showing exemplary interactions in this context. In particular, this diagram shows interactions occurring (along a time axis 301) among elements within a WiMAX access network 350, and a 3GPP EPC 306. In this diagram, each interaction may include, for example, one or more acts, actions, exchanges, and/or events.

As shown in FIG. 3, WiMAX access network 350 includes a mobile station (MS) 302, a base station (BS) 304, and an ASN-GW 306. Also, FIG. 3 shows 3GPP EPC 360 including a visited AAA proxy 308, and a home AAA server 310. These elements may be implemented in any combination of hardware and/or software.

These interactions may occur in the environment of FIG. 1. For instance, MS 302 may be implemented as user device 102, BS 304 may be implemented as one of base stations 114a-n, ASN-GW 308 may be implemented as ASN-GW 116, visited AAA server 310 may be implemented as AAA server 120. Embodiments, however, are not limited to this context.

At an interaction 320, mobile station 302 acquires a downlink (DL) channel, obtains media access control (MAC) synchronization (for instance, through the reception of a DL-MAP message), and obtains uplink (UL) link parameters.

At an interaction 322, initial ranging and physical layer (PHY) adjustments may be made. In the context of WiMAX, this may involve the exchange of RNG-REQ and RNG-RSP messages with base station 304.

Following this, mobile station 302 and base station 304 exchange SBC REQ and SBC RSP messages at an interaction 324. These messages involve the basic capabilities of MS 302. Also, at an interaction 326, an MS context initialization process occurs between BS 304 and ASN-GW 306.

FIG. 3 further shows an interaction 328, in which an authentication process (e.g., an EAP process) occurs. In particular, FIG. 3 shows this interaction involving MS 302, BS 304, ASN-GW 306, visited AAA server 308 (acting as a proxy), and home AAA server 310.

As indicated by a block 330, the authentication process indicates success. As a result, a security context is acquired. Thus, an interaction 332 shows MS 302 and ASN-GW 306 generating an authentication key (AK).

Following this, MS 302 and BS 304 engage in the generation and transfer of a security association (SA) and traffic encryption key (TEK) at an interaction 334.

At an interaction 336, MS 302 registers with BS 304. This may involve the exchange of WiMAX REG-REQ and REG-RSP messages. Also, an interaction 338 shows registration occurring with ASN-GW 306.

In the context of FIG. 2, interactions 320 through 336 may be included in block 202. As described above, block 202 involves the establishment of a connection between a user device and an access network.

Referring again to FIG. 3, an interaction 340 is shown following interactions 336 and 338. Interaction provides mobile station 302 with the ability to provide ASN-GW 306 with information needed to attach to a core network (e.g., a 3GPP EPC). In particular, FIG. 3 shows interaction 340 including messages 342 and 344.

Message 342 is a request message transmitted by MS 302. This message is received by BS 304 and transparently forwarded to ASN-GW 306. FIG. 3 shows message 342 being called EPC_ATTACH_REQ, as it requests attachment to a 3GPP EPC. However, embodiments may employ other names for such messages. Moreover, embodiments are not limited to WiMAX and/or 3GPP EPC implementations.

Message 344 is a response message corresponding to request message 342. FIG. 3 shows response message 344 being called EPC_ATTACH_RSP. However, embodiments may employ other names for such messages. Moreover, embodiments are not limited to WiMAX and/or 3GPP EPC implementations.

As indicated in FIG. 3, message 342 includes an attach type field, an APN field, and an MM capability field. FIG. 3 shows message 344 including an RSP type field, and an MM capability field. These fields of messages 342 and 344 may be implemented in the manner described above with reference to FIG. 2. However, embodiments are not limited to these implementations.

Following the exchange of messages 342 and 344, a service addition process 346 may occur between MS 302 and BS 304. In the context of WiMAX, this may involve the exchange of DSA-REQ, DSA-RSP, and DSA-ACK messages. Also, a data path establishment process 348 may occur between BS 304 and ASN-GW 306. Further, session establishment signaling may occur between ASN-GW 306 and a PDN-GW within EPC 360. Such signaling may include, for example, the exchange of proxy binding update (PBU) and proxy binding acknowledgment (PBA) messages.

Following these processes, MS 302 may establish communications with its selected access point (external network). As described herein, this may involve the establishment of a mobile IP tunnel (e.g., a PMIP tunnel).

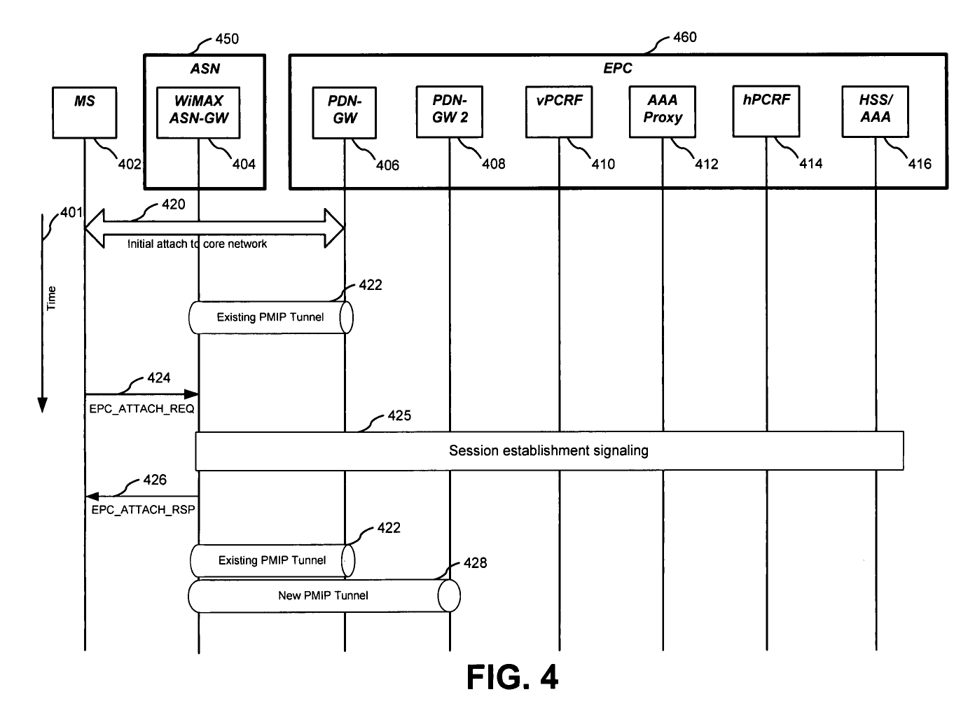

The techniques described herein may also be employed for connection to multiple external packet data networks (PDNs). Accordingly, FIG. 4 is a diagram showing a user device (e.g., a mobile station) establishes attachments to two PDNs via two different PDN-GWs. In particular, FIG. 4 shows interactions occurring (along a time axis 401) among entities within a WiMAX access services network (ASN) 450, and a 3GPP EPC 460. In this diagram, each interaction may include, for example, one or more acts, actions, exchanges, and/or events. As shown in FIG. 4, ASN 450 may include a mobile station (MS) 402, and a WiMAX ASN-GW 404. Further, FIG. 4 shows that EPC 460 may include a first PDN-GW 406, a second PDN-GW 408, a vPCRF 410, an AAA proxy 412, a hPCRF 414, and a HSS/AAA 416.

At an interaction 420, MS 402 attaches to EPC core 460. This attachment may be performed in the manner described with reference to FIG. 3. However, other attachment techniques may be employed. As shown in FIG. 4, this attachment results in a PMIP tunnel 422 being created between ASN-GW 404 and PDN-GW 406.

Following this attachment, MS 402 desires to establish a subsequent attachment. Accordingly, MS 402 sends an attachment request message 424 (shown as EPC_ATTACH_REQ 424) that is received by ASN-GW 404. MS 402 sets the Attach Type to “Additional PDN attachment”.

As indicated in FIG. 4 by reference number 425, this request message initiates session establishment signaling among WiMAX ASN-GW 404 and elements within EPC 460. This signaling may include the exchange of proxy binding update (PDU) and proxy binding acknowledgement (PBA) messages.

As a result of this signaling, a response message 426 (shown as EPC_ATTACH_RSP 426) is sent to MS 402. If the response message indicates that the request was granted, then a new PMIP tunnel 428 is established with second PDN-GW 408. Accordingly, MS 402 may have multiple concurrent attachments to EPC 460.

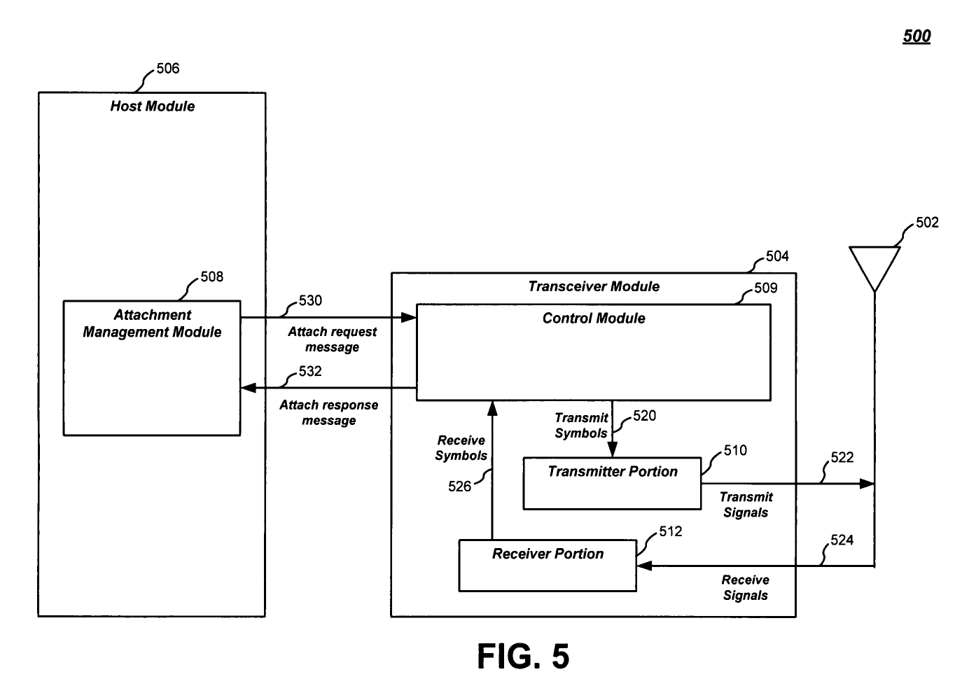

FIG. 5 is a diagram of an implementation 500 that may be included in user devices, such as user device 102 of FIG. 1, MS 302 of FIG. 3, and/or MS 402 of FIG. 4. This implementation, however, may be also employed in other contexts. Implementation 500 may include various elements. For example, FIG. 5 shows implementation 500 including an antenna 502, a transceiver module 504, and a host module 506. Further, FIG, 5 shows an attachment management module 508 within host module 506. These elements may be implemented in hardware, software, or any combination thereof.

Antenna 502 provides for the exchange of wireless signals with remote devices (such as base stations). Although a single antenna is depicted, multiple antennas may be employed. For example, embodiments may employ one or more transmit antennas and one or more receive antennas. Alternatively or additionally, embodiments may employ multiple antennas for beamforming, and/or phased-array antenna arrangements.

As shown in FIG. 5, transceiver module 504 includes a control module 509, a transmitter portion 510, and a receiver portion 512. During operation, transceiver module 504 provides an interface between antenna 502 and host module 506. For instance, transmitter portion 510 receives symbols 520 from control module 509, and generates corresponding signals 522 for wireless transmission by antenna module 502. This may involve operations, such as modulation, amplification, and/or filtering. However, other operations may be employed.

Conversely, receiver portion 512 obtains signals 524 received by antenna 502 and generates corresponding symbols 526. In turn, transceiver module 504 provides symbols 526 to control module 509. This generation of symbols 526 may involve operations, including (but not limited to) demodulation, amplification, and/or filtering.

Signals 522 and 524 may be in various formats. For instance, these signals may be formatted for transmission in IEEE 802.16e WiMAX networks. However, embodiments are not limited to these exemplary networks or signal formats. Transmitter portion 510 and receiver portion 512 may each include various components. Exemplary components include modulators, demodulators, amplifiers, filters, buffers, upconverters, and/or downconveters. Such components may be implemented in hardware (e.g., electronics), software, or any combination thereof.

Control module 509 manages various operations of transceiver module 504. For example, control module 509 manages the employment of various physical layer and media access control techniques. Also, as described above, control module 509 exchanges symbols with transmitter portion 510 and receiver portion 512. In turn, control module 509 may exchange corresponding information (e.g., messages and/or symbols) with host module 506.

The information exchanged between host module 506 and control module 509 may form messages or information associated with one or more protocols, and/or with one or more user applications. Thus, host module 506 may perform operations corresponding to such protocol(s) and/or user application(s). Exemplary protocols include various media access control, network, transport, signaling, and/or session layer protocols. Exemplary user applications include telephony, messaging, e-mail, web browsing, content (e.g., video and audio) distribution/reception, and so forth.

As an example, FIG. 5 shows attachment management module 508 exchanging messages with control module 509 within transceiver module 504. In particular, attachment management module 508 is shown sending an attachment request message 530 (e.g., an EPC_ATTACH_REQ message). Also, attachment management module 508 is shown receiving a corresponding attachment response message 532 (e.g., an EPC_ATTACH_RSP message). As described herein, these messages are exchanged with remote entities (via transceiver module 504 and antenna 502).

Thus, attachment management module 508 may generate attachment request messages. Such generation may be in response to various events, such as user activation or selection. Also, attachment management module 508 receives and processes attachment response messages. Based on this processing, communications with external networks (also referred to as access points) may occur.

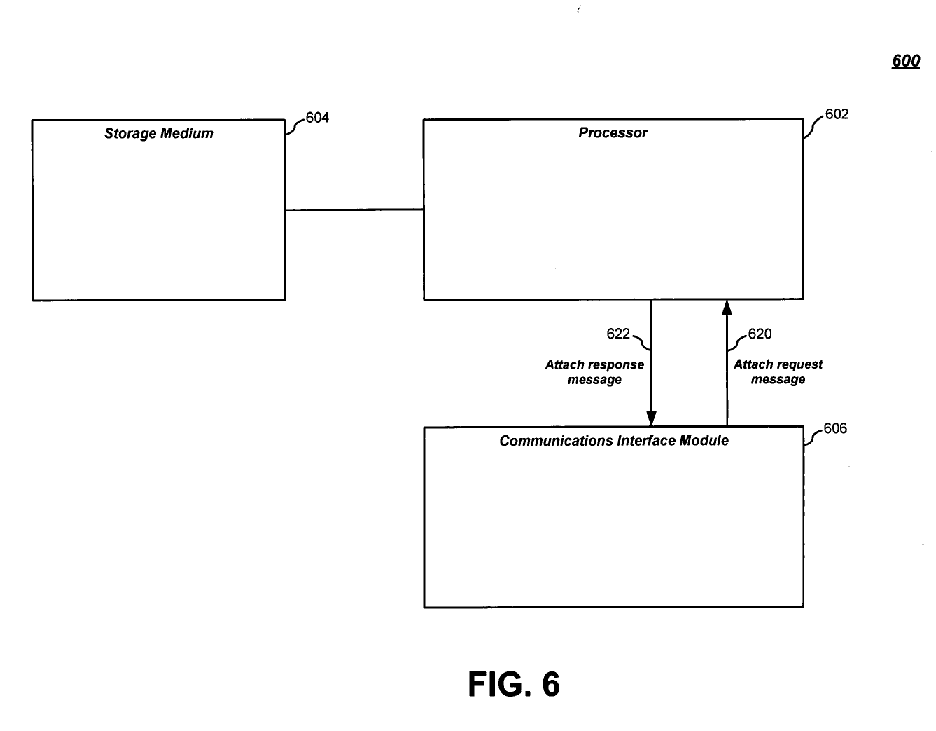

FIG. 6 is a diagram of an implementation 600 that may be included in ASN-GWs, such as ASN-GW 116 of FIG. 1, ASN-GW 306 of FIG. 3, and/or ASN-GW 404 of FIG. 4. This implementation, however, may be also employed in other contexts. Implementation 600 may include various elements. For example, FIG. 6 shows implementation 600 including a processor 602, a storage medium 604, and a communications interface module 606.

Storage medium 604 may store instructions that are executed by processor 602. Exemplary storage media are described in greater detail below. Processor 602 may execute instructions stored in storage medium 604. Such instructions may provide ASN-GW features, as described herein. For example, FIG. 6 shows processor 602 receiving an attach request message 620 and sending a corresponding attach response message 622. Processor 602 may process and generate such messages according to the ASN-GW techniques described herein.

Processor 602 exchanges messages 620 and 622 with communications interface module 606. In turn, communications interface module 606 exchanges these messages with a base station. As described herein, the base station exchanges these messages with a user device. Also, communications interface module provides for the exchange of information with other entities (e.g., AAA servers, PDN-GWs, and so forth). Communications interface 606 may include various components, such as transceiver(s), network interface card(s), and so forth. Such components may be implemented in any combination of hardware and/or software.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Some embodiments may be implemented, for example, using a storage medium or article which is machine readable. The storage medium may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

The storage medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While various embodiments of the present invention have been described above, it should be understood that they have been presented by way of example only, and not in limitation. For example, the techniques described herein are not limited to IEEE 802.16e networks or 3GPP EPC networks.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An apparatus, comprising:
a transceiver to exchange wireless signals with a wireless access network;
an attachment control module to:
generate a request message for wireless transmission to the wireless access network by the transceiver, the request message for requesting attachment to a core network, and
receive a response message from the wireless access network through the transceiver;
wherein the request message includes:
a field to indicate an attachment type,
a field to indicate an access point name, and
a field to indicate a mobility mode capability of a user device.

2. The apparatus of claim 1, wherein the response message includes:
a field to indicate whether the corresponding request was granted; and
a field to indicate a selected mobility mode for the user device.

3. The apparatus of claim 1, wherein the wireless access network is a WiMAX network, and the core network is a 3GPP enhanced packet core (EPC).

4. The apparatus of claim 1, wherein the field to indicate attachment type indicates one of an initial attachment, additional PDN attachment, and a handover attachment.

5. The apparatus of claim 1, wherein the field to indicate a mobility mode capability of the user device indicates a mobile Internet Protocol (IP).

6. The apparatus of claim 1, wherein the field to indicate an access point name identifies a service provided by an external network.

7. The apparatus of claim 1, wherein when the response message indicates that the request is granted, the transceiver is to establish a data path with first and second gateways, wherein the first gateway is within the wireless access network and the second gateway is within the core network.

8. A method, comprising:
sending, from a user device, a request message to a wireless access network, the request message for requesting attachment to a core network; and
receiving, at the user device, a response message from the access network, the response message indicating whether the request is granted;
wherein the request message includes:
a field to indicate an attachment type,
a field to indicate an access point name, and
a field to indicate a mobility mode capability of the device.

9. The method of claim 8, wherein the wireless access network is a WiMAX network, and the core network is a 3GPP enhanced packet core (EPC).

10. The method of claim 8, wherein the access point name identifies a service provided by an external network.

11. The method of claim 8, wherein the response message includes:
a field to indicate whether the corresponding request was granted; and
a field to indicate a selected mobility mode for the user device.

12. The method of claim 8, further comprising:
when the response message indicates that the request is granted, establishing a data path with first and second gateways, wherein the first gateway is within the wireless network and the second gateway is within the core network.

13. The method of claim 12, wherein the first gateway is a WIMAX access services network gateway (ASN-GW), and wherein the second gateway is a 3GPP packet data network gateway (PDN-GW).

14. The method of claim 12, wherein the second gateway provides access to an access point name indicated in the request message.

15. The method of claim 8, further comprising:
at the wireless access network;
receiving the request message,
generating the response message, and
sending the response message to the user device.

16. The method of claim 15, further comprising:
At the wireless access network, determining whether the user is authorized for the access point name.

17. An article comprising a computer-accessible medium having stored thereon instructions that, when executed by a computer, cause the computer to:
send, from a user device, a request message to a wireless access network, the request message for requesting attachment to a core network; and
receive, at the user device, a response message from the access network, the response message indicating whether the request is granted;
wherein the request message includes:
a field to indicate an attachment type,
a field to indicate an access point name, and
a field to indicate a mobility mode capability of the device.

18. The article of claim 17, wherein the instructions, when executed by a computer, further cause the computer to:
when the response message indicates that the request is granted, establish a data path with first and second gateways, wherein the first gateway is within the wireless network and the second gateway is within the core network.

19. The article of claim 17, wherein the wireless access network is a WiMAX network, and the core network is a 3GPP enhanced packet core (EPC).

20. The article of claim 17, wherein the access point name identifies a service provided by an external network.
